(19) United States
(12) Patent Application Publication
(10) Pub. No.: US 2026/0125611 A1
(43) Pub. Date: May 7, 2026

(54) MODIFIED REPEAT UNIT FOR ENHANCED INTERACTION ENERGY AND THERMAL STABILITY OF HIGH TEMPERATURE LUBRICANTS FOR MAGNETIC MEDIA

(71) Applicant: Western Digital Technologies, Inc., San Jose, CA (US)

(72) Inventors: Daniel Demori Maksuta, San Jose, CA (US); Hantao Zhou, San Jose, CA (US); Ao Fan, Shenzhen (CN); Jianming Wen, Pleasanton, CA (US); Charles Cheng-Hsing Lee, San Jose, CA (US)

(21) Appl. No.: 18/940,469

(22) Filed: Nov. 7, 2024

(51) Int. Cl. C10M 107/38; C10M 177/00; C10N 30/08; C10N 40/18; G11B 5/00; G11B 5/72; G11B 5/725

(52) U.S. Cl. CPC C10M 107/38; C10M 177/00; G11B 5/7257; C10N 2030/08; C10N 2040/18; G11B 2005/0021; G11B 5/7266

(57) ABSTRACT

High temperature lubricants for magnetic recording media are provided. One such lubricant has a plurality of segments according to general formula (I):

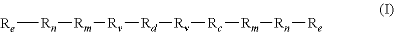

where Rₙ when present is a C₁-C₄ repeating unit having a dipole moment greater than 0.036 D, Rₘ when present is a C₁-C₄ repeating unit having a dipole moment greater than 0.036 D and enthalpy of vaporization between 17 kJ/mol and 40.7 kJ/mol but different than Rₙ, and at least one of Rₙ or Rₙ is present, Rₑ is a first anchoring functional group, Rᵥ is optionally a second anchoring functional group and R_{d} is a linker.

### FIELD

The disclosure relates to lubricants, and more particularly, to high temperature lubricants, which may be used with media configured for magnetic recording, e.g., for Heat Assisted Magnetic Recording (HAMR) having modified repeat units with optimized dipole moments and enthalpies.

### INTRODUCTION

Magnetic storage systems, such as a hard disk drive (HDD), are utilized in a wide variety of devices in both stationary and mobile computing environments. Examples of devices that incorporate magnetic storage systems include data center storage systems, desktop computers, portable notebook computers, portable hard disk drives, network storage systems, high definition television (HDTV) receivers, vehicle control systems, cellular or mobile telephones, television set top boxes, digital cameras, digital video cameras, video game consoles, and portable media players.

A typical disk drive includes magnetic storage media in the form of one or more flat disks or platters. The disks generally include two main components, namely, a substrate material that gives it structure and rigidity, and a magnetic medium coating that stores the magnetic signals that represent data in a recording layer within the coating. The typical disk drive also includes a read head and a write head, generally in the form of a magnetic transducer which can sense and/or change the magnetic fields stored on the recording layer of the disks. HAMR is a recording technique that can increase the areal density capability (ADC) of written data on a magnetic storage medium having very high coercivity with high-temperature assistance. However, the high recording temperatures applied to the medium may present challenges. Other examples of magnetic storage media include flexible tape media usable for magnetic tape recording.

As a result of the high temperatures associated with HAMR technology, suitable lubricants for use in HAMR media may benefit from high thermal stability. However, high temperatures may increase the presence of contaminants and cause thermally activated reactions such as decomposition and polymerization which will cause discoloring, i.e., fogging, of the storage medium. It is therefore desirable to find lubricant chemistries that will inhibit thermally activated reactions while maintaining high evaporation temperature. As such, there is a need in the art for high temperature lubricants having properties suitable for use in HAMR drives, including repeat units that enhance interaction energy and thermal stability.

### SUMMARY

In one aspect, this disclosure, in part, provides a lubricant that may include a number of segments according to general formula (I):

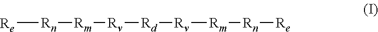

where Rₙ when present is a C₁-C₄ fluorinated repeating unit having a dipole moment greater than 0.036 debye (D), Rₘ when present is a C₁-C₄ fluorinated repeating unit having a dipole moment greater than 0.036 D but different than Rₙ, and at least one of Rₙ or Rₘ is present, Rₑ is a first anchoring functional group, Rᵥ is optionally a second anchoring functional group.

In the disclosure, the dipole moment of Rₙ and Rₘ may be each independently in a range of 0.036 D to 1.69 D. Rₙ or Rₘ, when present, may have an enthalpy of vaporization of greater than 17 kiloJoules per mole (kJ/mole) and less than 40.7 kJ/mol. Re may have an enthalpy of vaporization of between 60 kJ/mol and 70 kJ/mol.

In the disclosure, Rₙ and Rₘ may be each independently selected from:

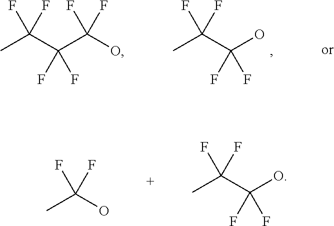

In the disclosure, Rₙ and Rₘ may each be independently formed from: benzyl phenyl ether, phenylmethyl ether, dimethyl ether, difluorodimethyl ether or perfluorodimethyl ether. Rₙ and Rₘ may each independently include moieties selected from hexafluoroacetone, heaxfluoroisopropanol, perfluoroethanamine, 3,3,3-Trifluoro-2-(trifluoromethyl)propanal or 1,1,1-Trifluoro-N-(trifluoromethyl)methanamine. Rₑ and Rᵥ may independently each include at least one of B, Si, a pnictogen, a chalcogen, a halogen, —OR*, —NR*₂, —NR*—CO—R*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure, or a hydroxyl (—OH) moiety.

The disclosure, in part, pertains to a data storage system that may include at least one magnetic head; a magnetic recording medium including the lubricant of the disclosure; a drive mechanism for positioning the at least one magnetic head over the magnetic recording medium; and a controller electrically coupled to the at least one magnetic head for controlling operation of the at least one magnetic head. In the data storage system, the lubricant may be a monolayer with an average thickness being in the range of 5 to 12 Å, or at 8 Å.

The disclosure, in part, pertains to a magnetic recording medium that may include a magnetic recording layer on a substrate; a protective overcoat on the magnetic recording layer; and a lubricant layer comprising the lubricant according to the disclosure on the protective overcoat.

The disclosure, in part, pertains to a data storage system that may include a slider formed from at least one magnetic head and an air bearing surface (ABS), where the lubricant according the disclosure is disposed on the ABS; and a magnetic recording medium including a magnetic recording layer; where the slider is configured to write information to the magnetic recording layer using heat assisted magnetic recording (HAMR).

The disclosure, in part, pertains to a method of synthesizing a component of the lubricant of the disclosure, that may include atom transfer radical polymerization (ATRP) followed by Simon's/Fowler's process to yield formula (IX):

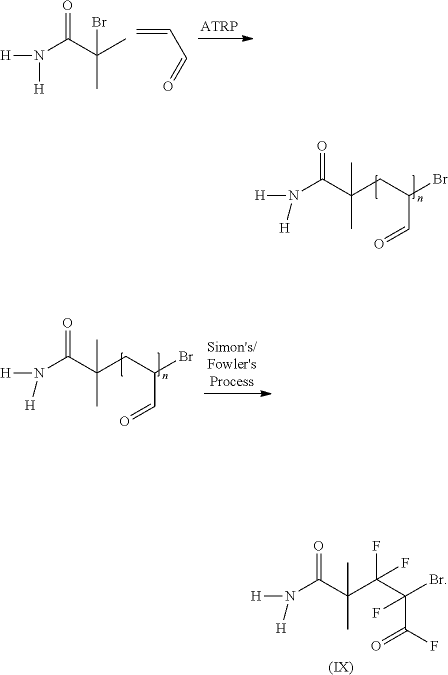

The disclosure, in part, pertains to a method of synthesizing a component of the lubricant of the disclosure, that may include a ring opening based on cyclobutane polymerization using an acid or base to yield a lubricant of formula (X):

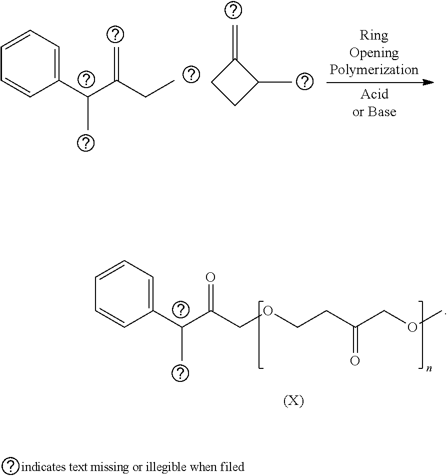

The disclosure, in part, pertains to a method of synthesizing a component of the lubricant of the disclosure, that may include a non-fluorinated polymer by Simon/Fowler's process to yield formula (XI):

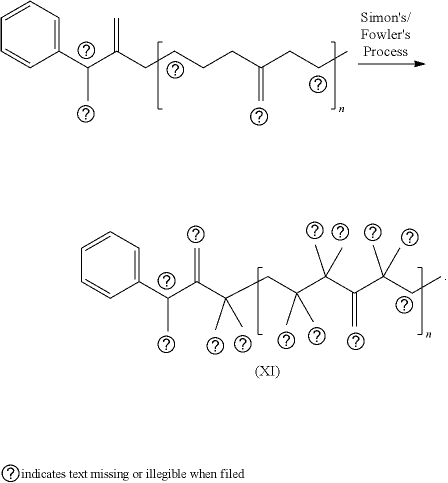

The disclosure, in part, pertains to a lubricant that may be formed from plurality of segments according to general formula (I):

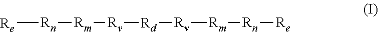

where Rₙ when present may be a C₁-C₄ fluorinated repeating unit having an enthalpy of vaporization of greater than 17 kiloJoules per mole (kJ/mole) and less than 40.7 kJ/mol, Rₘ when present is a C₁-C₄ fluorinated repeating unit having an enthalpy of vaporization of greater than 17 kJ/mole and less than 40.7 kJ/mol, but different than Rₙ, and at least one of Rₙ or Rₘ is present, Rₑ is a first anchoring functional group, Rᵥ is optionally a second anchoring functional group, and R_{d} is a linker

In the disclosure, Rₑ may have an enthalpy of vaporization of between 60 and 70 kJ/mol. A dipole moment of Rₙ and Rₘ may each independently be in a range of 0.036 D to 1.69 D. Rₙ and Rₘ may each be each independently selected from:

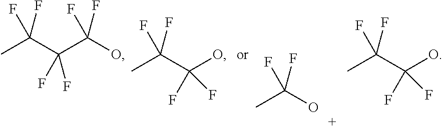

Other aspects and advantages of the present disclosure will become apparent from the following detailed description and examples, when considered in conjunction with the drawings.

### BRIEF DESCRIPTION OF THE DRAWINGS

FIG. 1A is a diagram schematically illustrating a data storage device including a slider and a magnetic recording medium in accordance with one aspect of the disclosure.

FIG. 1B is a side schematic view of the slider and magnetic recording medium of FIG. 1A in accordance with one aspect of the disclosure.

FIG. 2 is a side schematic view of a heat assisted magnetic recording (HAMR) medium in accordance with one aspect of the disclosure.

FIG. 3A is a schematic drawing showing a lubricant according to the disclosure including a single main chain segment and a functional group according to one aspect of the disclosure.

FIG. 3B is a schematic drawing showing a lubricant according to the disclosure including a single main chain segment and a multitude of functional groups according to one aspect of the disclosure.

FIG. 3C is a schematic drawing showing a lubricant according to the disclosure including two chain segments with terminal cyclic functional groups and separated by a linking segment according to one aspect of the disclosure.

FIG. 3D is a schematic drawing showing a lubricant according to the disclosure including two chain segments with terminal cyclic functional groups and separated by a linking segment formed from cyclic functional groups according to one aspect of the disclosure.

FIG. 3E is a schematic drawing showing a lubricant according to the disclosure including two chain segments with terminal functional groups and separated by a linking segment according to one aspect of the disclosure.

FIG. 4 shows the structure and dipole moments for benzylphenyl ether (BPhEther, μ=2.03 D), phenylmethyl ether (PhMeEther, μ=1.31 D), dimethyl ether (DME, μ=1.46 D), difluorodimethyl ether (DFDME, μ=3.40 D) and perfluorodimethyl ether (PFDME, μ=0.036 D) according to one aspect of the disclosure.

FIG. 5 shows the enhancement of interaction energy as a function of the structure of the repeating unit according to one aspect of the disclosure.

FIG. 6 shows the benefits of utilizing interaction energy to decrease lube loss on the disk surface according to one aspect of the disclosure.

FIG. 7 shows an example of the type of structures that can enhance the dipole moment of the molecule according to one aspect of the disclosure.

FIG. 8 is a flowchart of an exemplary process for fabricating a HAMR medium that includes a magnetic recording layer, a capping layer, an overcoat and a lubricant, in accordance with an aspect of the disclosure.

### DETAILED DESCRIPTION

Heat Assisted Magnetic Recording (HAMR) systems operate at substantially higher temperatures than traditional magnetic recording systems. HAMR is an example of magnetic recording within the class of Energy Assisted Magnetic Recording (EAMR) techniques, where conventional magnetic recording is supplemented by other energy used in the system. Other examples of EAMR may include Microwave Assisted Magnetic Recording (MAMR) and applications of electric current into various conductive and/or magnetic structures near the main pole. This disclosure is generally directed to lubricants having high thermal stability that can be used in conjunction with a magnetic recording medium and/or a magnetic data storage system including a HAMR, or more generally EAMR, magnetic recording medium or storage system.

In short, the disclosure pertains to high temperature lubricants, which may be used with media configured for magnetic recording, e.g., for HAMR, having more thermally stable end groups.

In general, the lubricant of the disclosure can have the general formula (I):

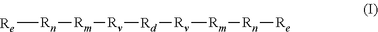

where Rₙ when present is a C₁-C₄ fluorinated repeating unit having a dipole moment greater than 0.036 debye (D), Rₘ when present is a C₁-C₄ fluorinated repeating unit having a dipole moment greater than 0.036 D but different than Rₙ, and at least one of Rₙ and Rₘ is present. Rₙ and Rₘ additionally may optionally have an enthalpy of vaporization between 17 kJ/mol (typical fluorinated repeat unit) and 40.7 kJ/mol, which may be independent of the dipole moment. Rₑ is an anchoring functional group, Rᵥ is optionally an anchoring functional group that may or may not be different from Rₑ, and R_{d} is a linker.

The anchoring functional group Rₑ or Rᵥ may be at least one of —OH, —NH₂, —NH—CO—H, —O—CO—H, —CO—O—H, —SeH, —TeH, —PH₂, —PO—(OH)₂, —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof. The linker R_{d} may be a divalent or multivalent linking segment.

As shown in formula (I), R_{d} is divalent. However, R_{d} can be multivalent so that a star shaped lubricant may result. Formula (I) can thus be rewritten as formula (Ia):

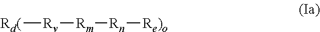

where o is from 2 to 6 and R_{d}, Rᵥ, Rₘ, Rₙ and Rₑ are defined above.

The lubricant of the disclosure may also be formed from a plurality of segments according to general formula (II), (III), or (IV):

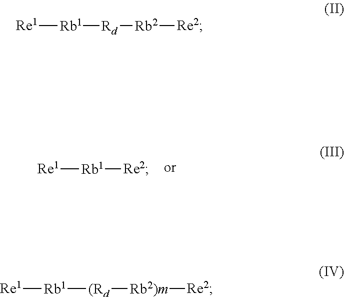

where R_{d}, when present, is a divalent linking segment that optionally includes a first anchoring functional group engageable with a protective overcoat of a magnetic recording medium; where each Rb¹ and Rb², when present, independently includes a chain segment including at least one functional group having a dipole moment larger than 0.036 D; where each of Re¹ and Re² independently includes a group at least one second anchoring functional group engageable with the protective overcoat of the magnetic recording medium optionally including CH₂OCH₂(CH₂)ₙ(Ra)ₙ₋₁ or —OCH₂(CH₂)ₙ(Ra)ₙ₋₁, Ra is the second anchoring functional group where n=1-10 and m=1-100. Among the anchoring functional groups, the first and second anchoring functional groups each most commonly are a hydroxyl (—OH) moiety.

### Definitions

As used herein, and unless otherwise specified, the term “Cₙ” means hydrocarbon(s) having n carbon atom(s) per molecule, where n is a positive integer. Likewise, a “Cₘ-C_{y}” group or compound refers to a group or compound formed from carbon atoms at a total number thereof in the range from m to y. Thus, a C₁-C₄ alkyl group refers to an alkyl group that includes carbon atoms at a total number thereof in the range of 1 to 4, e.g., 1, 2, 3 and 4.

“Moiety” refers to one or more covalently bonded atoms which form a part of a molecule. The terms “group,” “radical,” “moiety”, and “substituent” may be used interchangeably.

The terms “hydrocarbyl radical,” “hydrocarbyl group,” or “hydrocarbyl” may be used interchangeably and are defined to mean a group formed from hydrogen and carbon atoms only. Hydrocarbyls are C₁-C₅₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl, naphthyl, and the like.

For purposes herein, a heteroatom is any non-carbon atom, selected from groups 13 through 17 of the periodic table of the elements. In one or more aspects, heteroatoms are non-metallic atoms selected from B, Si, pnictogens (N, P, As, Sb, Bi), chalcogen (O, S, Se, Te), and halogens (F, Cl, Br, I).

Unless otherwise indicated, the term “substituted” means that at least one hydrogen atom has been replaced with at least one non-hydrogen atom or a functional group.

For purposes herein, when a segment includes a particular moiety, it is to be understood that the moiety may be bonded to the respective segment at any substitutable position in which a hydrogen atom may be replaced with a chemical bond between the moiety and the segment.

For purposes herein, a functional group includes one or more of a hydrocarbyl group, a heteroatom, or a heteroatom containing group, such as B, Si, pnictogen, chalcogen, or halogen (such as Br, Cl, F or I), at least one of —OR*, —NR*₂, —NR*—CO—R*, —OR*,*—O—CO—R*, —CO—O—R*, —SeR*, —TeR*, —PR*₂, —PO—(OR*)₂, —O—PO—(OR*)₂, —AsR*₂, —SbR*₂, —SR*, —SO₂—(OR*)₂, —BR*₂, —SiR*₃, —(CH₂)_{q}—SiR*₃, or a combination thereof, wherein q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure, or where at least one heteroatom has been inserted within a hydrocarbyl ring. In an aspect, R* is H such that the functional group may be —OH, —NH₂, —NH—CO—H, —OH, H—O—CO—H, —CO—O—H, —SeH, —TeH, —PH₂, —PO—(OH)₂, —O—PO—(OH)₂, —AsH₂, —SbH₂, —SH, —SO₂—(OH)₂, —BH₂, —SiH₃, —(CH₂)_{q}—SiH₃, or a combination thereof.

In one or more aspects, functional groups may include: a saturated C₁-C₅₀ radical, an unsaturated C₁-C₅₀ radical, an alicyclic C₃-C₅₀ radical, a heterocyclic C₃-C₅₀ radical, an aromatic C₅-C₅₀ radical, a heteroaromatic C₅-C₅₀ radical, a cyclotriphosphazine radical, a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, pnictogen, chalcogen, halogen, saturated, unsaturated, aromatic, polycyclic aromatic, heteroaromatic, alicyclic, and/or heterocyclic C₄-C₅₀ radical. Anchoring functional groups can also be at least one of —OH, —NH₂, —NH—CO—H, —O—CO—H, —CO—O—H, —SeH, —TeH, —PH₂, —PO—(OH)₂, —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof.

For purposes herein, a cyclic functional group is a monovalent alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. Unless otherwise indicated, the cyclic functional group may be further substituted with another cyclic functional group and/or with one or more functional groups including one or more of a saturated C₁-C₅₀ radical, an unsaturated C₁-C₅₀ radical, an alicyclic C₃-C₅₀ radical, a heterocyclic C₃-C₅₀ radical, an aromatic C₅-C₅₀ radical, a heteroaromatic C₅-C₅₀ radical, a cyclotriphosphazine radical, a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, or a saturated, unsaturated, aromatic, polycyclic aromatic, heteroaromatic, alicyclic, and/or heterocyclic C₁-C₅₀ radical.

For purposes as described herein, an anchoring functional group which is selected for being attachable to and/or engageable with a protective overcoat of a magnetic recording medium refers to a functional group having increased affinity for the protective overcoat of the magnetic recording medium relative to the affinity of a fluoroalkenyl ether moiety, a perfluoroalkyl ether moiety, a perfluoroalkenyl ether moieties, to that same surface. Increased affinity may include Van der Waals forces, weak London Dispersion forces, dipole-dipole forces, polar interactions, polarizability/hydrogen bonding interactions, and/or the like, and/or may include the formation of one or more types of bonds, backbonding (where electrons are donated from a metal atom to a vacant orbital on a ligand), and/or dative bonds with the protective overcoat of a recording medium. In one or more aspects, a functional group which is attachable to and/or engageable with a protective overcoat of a magnetic recording medium refers to one or more functional groups having increased affinity for the carbon overcoat (COC) layer of the recording medium, relative to the affinity of a fluoroalkenyl ether moiety, a perfluoroalkyl ether moiety, a perfluoroalkenyl ether moieties to that same surface. In some aspects, functional groups attachable to and/or engageable with a protective overcoat of a magnetic recording medium include radicals formed from one or more hydroxyl moieties (—OH), or a single hydroxyl moiety (—OH).

A “heterocyclic ring,” also referred to herein as a heterocyclic radical, is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring is a heterocyclic ring where a hydrogen of one of the ring atoms is substituted, e.g., replaced with a hydrocarbyl, or a heteroatom containing group.

A “compound” refers to a substance formed by the chemical bonding of a plurality chemical elements. A “derivative” refers to a compound in which one or more of the atoms or functional groups of a precursor compound have been replaced by another atom or functional group, generally by means of a chemical reaction having one or more steps.

Fluorinated alkyl ethers including fluoroalkyl ethers, fluoroalkenyl ethers, perfluoroalkyl ethers, perfluoroalkenyl ethers, or combinations thereof, refer to branched or linear chain of C₁ to C₂₀ alkyl ethers in which one or more hydrogen atoms are substituted with fluorine. In one aspect, all or a majority of alkyl hydrogen atoms are substituted with fluorine.

For any particular compound disclosed herein, any general or specific structure presented also encompasses all conformational isomers, regio-isomers, and stereoisomers that may arise from a particular set of substituents, unless stated otherwise. Similarly, unless stated otherwise, the general or specific structure also encompasses all enantiomers, diastereomers, and other optical isomers whether in enantiomeric or racemic forms, as well as mixtures of stereoisomers, as would be recognized by a skilled artisan.

As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

As used herein, a moiety which is chemically identical to another moiety is defined as being identical in overall composition exclusive of isotopic abundance and/or distribution, and/or exclusive of stereochemical arrangement such as optical isomers, confirmational isomers, spatial isomers, and/or the like.

### HAMR System for Employing Lubricant

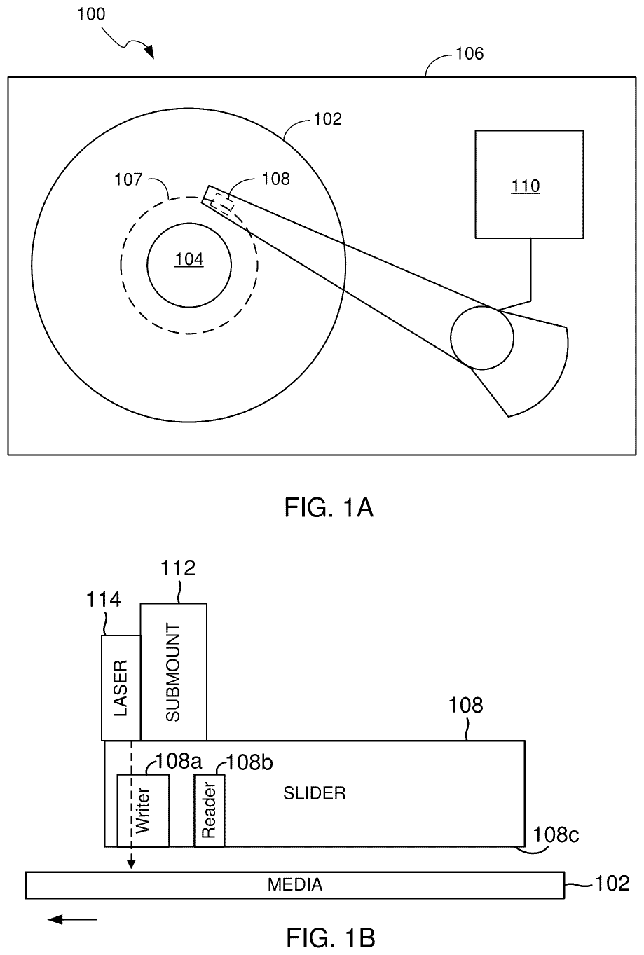

FIG. 1A is a top schematic view of a data storage device 100 (e.g., disk drive or magnetic recording device) configured for heat assisted magnetic recording (HAMR) including a slider 108 and a magnetic recording medium 102 having a lubricant according to one or more aspects of the disclosure. The laser (not visible in FIG. 1A, but see 114 in FIG. 1B) is positioned with a head/slider 108. Disk drive 100 may include one or more disks/media 102 to store data. Disk/media 102 resides on a spindle assembly 104 that is mounted to a drive housing. Data may be stored along tracks in the magnetic recording layer of disk 102. The reading and writing of data is accomplished with the head 108 (slider) that may have both read and write elements (108a and 108b). The write element 108a is used to alter the properties of the magnetic recording layer of disk 102 and thereby write information thereto. In one aspect, head 108 may have magneto-resistive (MR), giant magneto-resistive (GMR), or tunnel magneto-resistive (TMR) elements. In an alternative aspect, head 108 may be another type of head, for example, a Hall effect head. In operation, a spindle motor (not shown) rotates the spindle assembly 104, and thereby rotates the disk 102 to position the head 108 at a particular location along a desired disk track 107. The position of the head 108 relative to the disk 102 may be controlled by the control circuitry 110 (e.g., a microcontroller). It is noted that while an example HAMR system is shown, the various embodiments described may be used in other EAMR or non-EAMR magnetic data recording systems, including perpendicular magnetic recording (PMR) disk drives or magnetic tape drives.

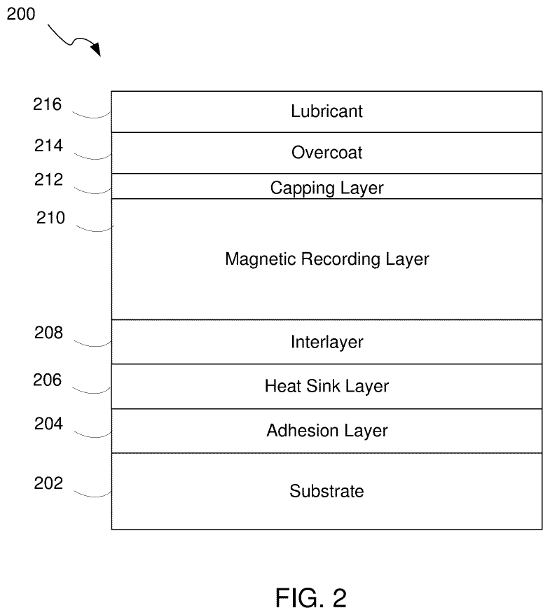

FIG. 1B is a side schematic view of the slider 108 and magnetic recording medium 102 of FIG. 1A. The magnetic recording medium 102 includes a lubricant layer (see FIG. 2) in accordance with one or more aspects of the disclosure. The slider 108 may include a sub-mount 112 attached to a top surface of the slider 108. The laser 114 may be attached to the sub-mount 112, and possibly to the slider 108. The slider 108 includes a write element (e.g., writer) 108a and a read element (e.g., reader) 108b positioned along an air bearing surface (ABS) 108c of the slider for writing information to, and reading information from, respectively, the medium 102. In other aspects, the slider may also include a layer of the lubricant (not shown).

In operation, the laser 114 is configured to generate and direct light energy to a waveguide (possibly along the dashed line) in the slider which directs the light to a near field transducer (NFT) near the air bearing surface (e.g., bottom surface) 108c of the slider 108. Upon receiving the light from the laser 114 via the waveguide, the NFT generates localized heat energy that heats a portion of the medium 102 near the write element 108a and the read element 108b. The anticipated recording temperature is in the range of about 350° C. to 400° C. In the aspect illustrated in FIG. 1B, the laser directed light is disposed between the writer 108a and a trailing edge of the slider. In other aspects, the laser directed light may instead be positioned between the writer 108a and the reader 108b. FIGS. 1A and 1B illustrate a specific aspect of a HAMR system. In other aspects, the magnetic recording medium 102 with the lubricant layer according to aspects of the disclosure can be used in other suitable HAMR systems (e.g., with other sliders configured for HAMR).

FIG. 2 is a side schematic view of a magnetic recording medium 200 having a lubricant layer according to one or more aspects of the disclosure. In one aspect, the magnetic recording medium 200 may be used in a HAMR system (e.g., disk drive 100). The magnetic recording medium 200 has a stacked structure with a substrate 202 at a bottom/base layer, an adhesion layer 204 on the substrate 202, a heat sink layer 206 on the adhesion layer 204, an interlayer 208 on the heat sink layer 206, a magnetic recording layer (MRL) 210 on the interlayer 208, a capping layer 212 on the MRL 210, an overcoat layer 214 on the capping layer 212, and a lubricant layer 216 on the overcoat layer 214. In one aspect, the magnetic recording medium 200 may have a soft magnetic underlayer (SUL) between the adhesion layer 204 and the heat sink layer 206. In one aspect, the magnetic recording medium 200 may have a thermal resistance layer (TRL) between the interlayer 208 and the heat sink layer 206. In one aspect, for disk drive applications, the substrate 202 can be made of one or more materials such as an Al alloy, NiP plated Al, glass, glass ceramic, and/or combinations thereof. In one aspect for magnetic tape recording applications, the substrate 202 can include a flexible material, such a film made of one of various types of resins, polyesters, polyolefins, polyamides, and the like, or combinations thereof. The substrate may include non-magnetic materials, and may be laminated. In some aspects, the magnetic recording medium 200 may have some or all of the layers illustrated in FIG. 2 and/or additional layer(s) in various stacking orders. It should also be noted that each layer shown in FIG. 2 may include one or more sub-layers. For example, the magnetic recording layer may include a multiple layers in certain embodiments. Also, some of the layers may be etched before the next layer is applied.

Lubricants according to aspects disclosed herein may function as boundary lubricants which may be used in various mechanical devices, including on the magnetic media of hard disk drives or tape drives and in conjunction with other microelectronic mechanical systems. Boundary lubricants may form a lubricant layer when one or more functional groups of the lubricant attach or otherwise engage with the surface being lubricated. For instance, one or more boundary lubricants may form the lubricant layer 216 on magnetic recording medium 200 (e.g., a disk that includes a magnetic recording layer 210) that moves relative to other parts in the magnetic storage device. This lubricant layer 216 may help to protect the magnetic recording medium from friction, wear, contaminations, smearing, and/or damages caused by interactions between the magnetic recording medium and other parts in the storage device (e.g., interactions between a slider and the magnetic recording medium). In other words, this boundary layer may help limit solid-to-solid contact.

While the HDD examples illustrated in FIGS. 1A, 1B, and 2 primarily relate to HAMR technology that involves the use of lubricants, the lubricants described herein may also be used in other magnetic recording technologies. These may include Microwave Assisted Magnetic Recording (MAMR), Perpendicular Magnetic Recording (PMR), Enterprise Perpendicular Magnetic Recording (ePMR), Shingled Magnetic Recording (SMR), or any other magnetic recording technology employing lubricants on magnetic media (e.g., magnetic recording disks or magnetic recording tape).

### Lubricant Characteristics

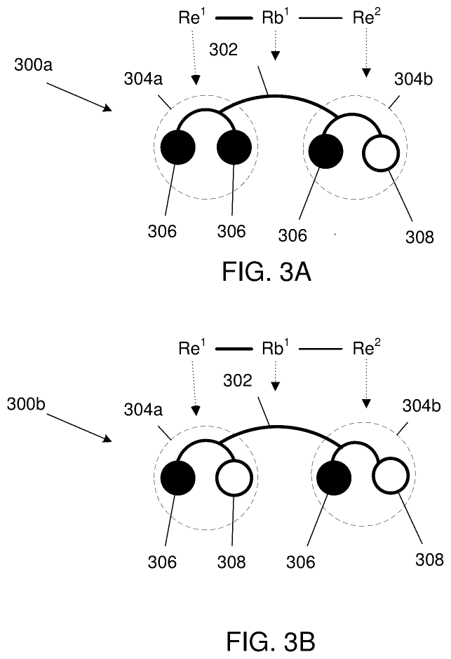

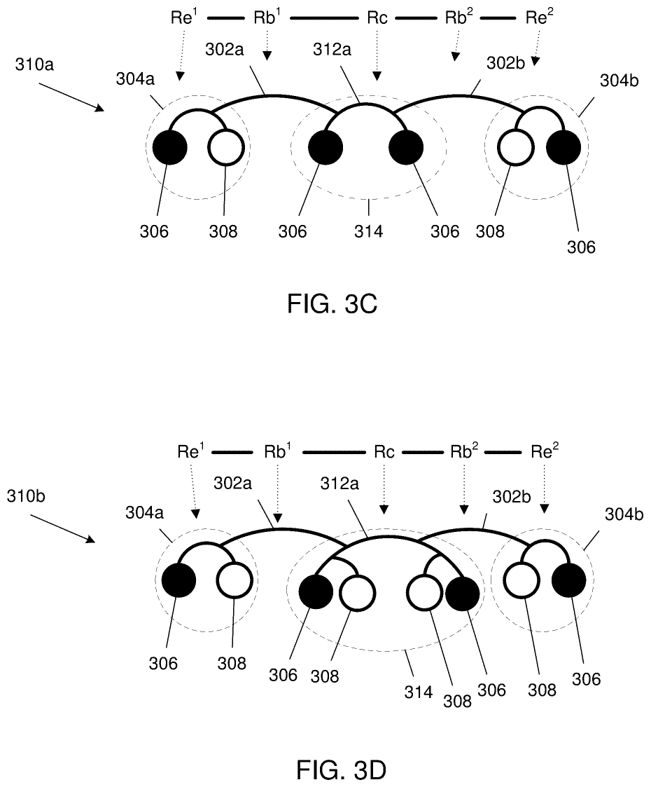

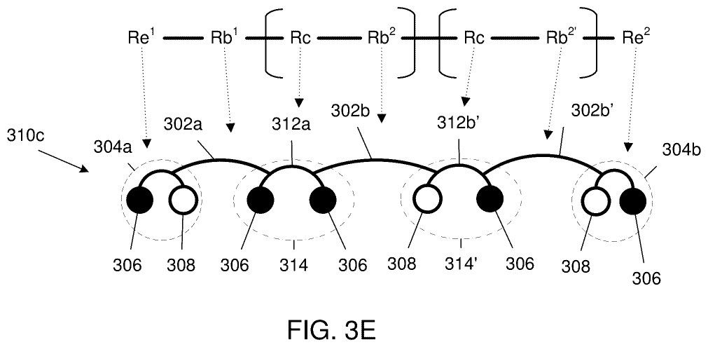

FIGS. 3A-3D illustrate boundary lubricants according to aspects of the disclosure. In one aspect as shown in FIG. 3A, the boundary lubricant generally referred to as 300a includes or may have general formula (V):

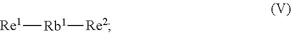

wherein Rb¹ (302) includes or is a chain segment having a repeating unit having an optimized dipole moment that can be, for example, a fluoroalkyl, fluoroalkenyl, perfluoroalkyl, or perfluoroalkyl ether moiety bonded on either side to an end segment 304a and 304b. In the aspect shown in FIG. 3A, the chain segment Rb¹ (302) may be also be referred to as a main chain segment. Re¹ (304a) and Re² (304b) are end segments which independently includes an anchoring functional group 306 selected for being attachable to and/or engageable with a protective overcoat of a magnetic recording medium (see FIG. 2). In the aspect shown, one or more of the end segments Re¹ (304a) and Re² (304b) includes a group that has a higher rotational energy barrier than CH₂, which can be for example benzene, anisole, other aromatic groups, (CF₂)ₙ where n=1-10, etc.

As shown in FIG. 3B, in one aspect indicated as 300b, each end group segment may include a cyclic or aromatic functional group 308.

In one aspect as shown in FIG. 3C, the boundary lubricant generally referred to as 310a may include or has general formula (VI):

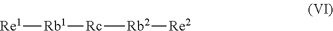

where the end segments Re¹ (304a) and Re² (304b) are as described above; in this aspect there are two chain segments Rb¹ (302a) and Rb² (302b), which may also be referred to herein as sidechain segments, both of which has a repeating group with an optimized dipole moment, which may independently include, for example, a fluoroalkyl, fluoroalkenyl, perfluoroalkyl, or perfluoroalkyl ether moiety.

As is indicated in FIG. 3C, whether referred to as a chain segment, a main chain segment (when only one is present), or a sidechain segment (when two or more are present), each of the segments are similar to one another in that segments may have an optimized dipole moment, and may include, for example, a fluoroalkyl, fluoroalkenyl, perfluoroalkyl, or perfluoroalkyl ether moiety.

In the aspect shown in FIG. 3C, the lubricant may further include a divalent linking segment Rc (312), generally indicated as 314, also referred to herein as a center segment, which is disposed between either end of the sidechain segments 302a and 302b, and which includes at least one anchoring functional group (306) as defined herein.

As shown in FIG. 3D, in one aspect generally indicated as 310b, the divalent linking segment Rc (312) may further include at least one cyclic functional group 308 as defined herein.

In one aspect as shown in FIG. 3E, the boundary lubricant generally referred to as 310c may have general formula (VII):

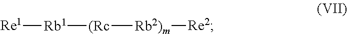

wherein m=2, including two units of the divalent linking segments; a first unit including Rc (312a) also generally indicated as (314), attached to a chain segment with an optimized dipole moment Rb² (302b), which is attached to a second unit including Rc (312b′) also generally indicated as (314′) and a second chain segment Rb²′ (302b′). The end segments Re¹ (304a) and Re² (304b) are attached to either end of the molecule. The composition of each of the segments may be independent of one another. The composition of each of the segments is according to the description of general formula (V) herein.

In one aspect, each anchoring functional group may independently include a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, or a saturated, unsaturated, aromatic, polycyclic aromatic, heteroaromatic, alicyclic, and/or heterocyclic C₁-C₅₀ radical, and two or more R* may join together to form a ring structure. When R* is H, the anchoring functional group can be OH, —NH₂, —NH—CO—H, —OH, —O—CO—H, —CO—O—H, —SeH, —TeH, —PH₂, —PO—(OH)₂, —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof.

In one aspect, each cyclic functional group may further include, e.g., may be further substituted with a functional group including at least one of a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, a saturated, unsaturated, aromatic, polycyclic aromatic, heteroaromatic, alicyclic, and/or heterocyclic C₁-C₅₀ radical, and two or more R* may join together to form a ring structure.

In one aspect, one or more anchoring functional group may include, or is, a hydroxyl (—OH) moiety. In one aspect, each anchoring functional group includes or is a hydroxyl (—OH) moiety. In some aspects, one or more cyclic functional groups may include a hydroxyl (—OH) moiety. In some aspects, each cyclic functional group includes a hydroxyl (—OH) moiety.

### Repeat Unit Modification

It has been unexpectedly found that incorporating larger dipole moments into the main-chain repeat unit can further enhance the binding of the lubricant to the disk and not the head. Incorporating repeat units with larger dipole moments should also improve the HDI (head to disk interface) clearance. For example, the dipole moment of CF₂OCF₂ is 0.036 debye (D).

In chemistry, the bond dipole moment uses the idea of electric dipole moment to measure the polarity of a chemical bond within a molecule. It occurs whenever there is a separation of positive and negative charges.

The bond dipole is given by:

$$μ = δ d .$$

The bond dipole is modeled as δ+-δ− with a distance d between the partial charges δ+ and δ−. It is a vector, parallel to the bond axis, pointing from minus to plus, as is conventional for electric dipole moment vectors.

Chemists often draw the vector pointing from plus to minus. This vector can be physically interpreted as the movement undergone by electrons when the two atoms are placed a distance d apart and allowed to interact, the electrons will move from their free state positions to be localized more around the more electronegative atom.

The SI unit for electric dipole moment is the coulomb-meter. This is too large to be practical on the molecular scale. Bond dipole moments are commonly measured in debyes, represented by the symbol D, which is obtained by measuring the charge.

δ has units of 10⁻¹⁰ statcoulomb and the distance d in Angstroms (Å). Based on the conversion factor of 10⁻¹¹ statcoulomb being 0.208 units of elementary charge, so 1.0 D results from an electron and a proton separated by 0.208 Å.

For diatomic molecules there is only one bond so the bond dipole moment is the molecular dipole moment, with typical values in the range of 0 to 11 D. At one extreme, a symmetrical molecule such as bromine, Br₂, has zero dipole moment, while near the other extreme, gas phase potassium bromide, KBr, which is highly ionic, has a dipole moment of 10.41 D.

For polyatomic molecules, there is more than one bond. The total molecular dipole moment may be approximated as the vector sum of the individual bond dipole moments. Often bond dipoles are obtained by the reverse process: a known total dipole of a molecule can be decomposed into bond dipoles. This is done to transfer bond dipole moments to molecules that have the same bonds, but for which the total dipole moment is not yet known. The vector sum of the transferred bond dipoles gives an estimate for the total (unknown) dipole of the molecule. The dipole moments of a number of molecules are set forth in Table 1.

TABLE 1
Dipole Moment of Various Chemical Compounds.

| Compound | Dipole Moment (D) |
|---|---|
| Water | 1.85 |
| Ethanol | 1.69 |
| Acetaldehyde | 2.69 |
| Acetone | 2.88 |
| Acetic Acid | 1.74 |
| Methyl acetate | 1.77 |
| Ethyl Acetate | 1.81 |
| n-hexane | 0.08 |
| 1-hexene | 0.34 |
| 1-hexyne | 0.83 |
| Cyclohexane | 0 |
| Cyclohexene | 0.55 |
| Benzene | 0 |
| Toluene | 0.36 |
| o-xylene | 0.62 |
| m-xylene | 0.37 |
| p-xylene | 0 |
| Isopropanol | 1.66 |
| TCE | — |
| n-hexane | 0 |
| benzylphenyl ether | 2.03 |
| dimethyl ether | 1.46 |
| difluorodimethyl ether | 3.40 |
| perfluorodimethyl ether | 0.036 |
| p-benzamide | 3.76 |
| 2,5 benzimidazole | 3.93 |

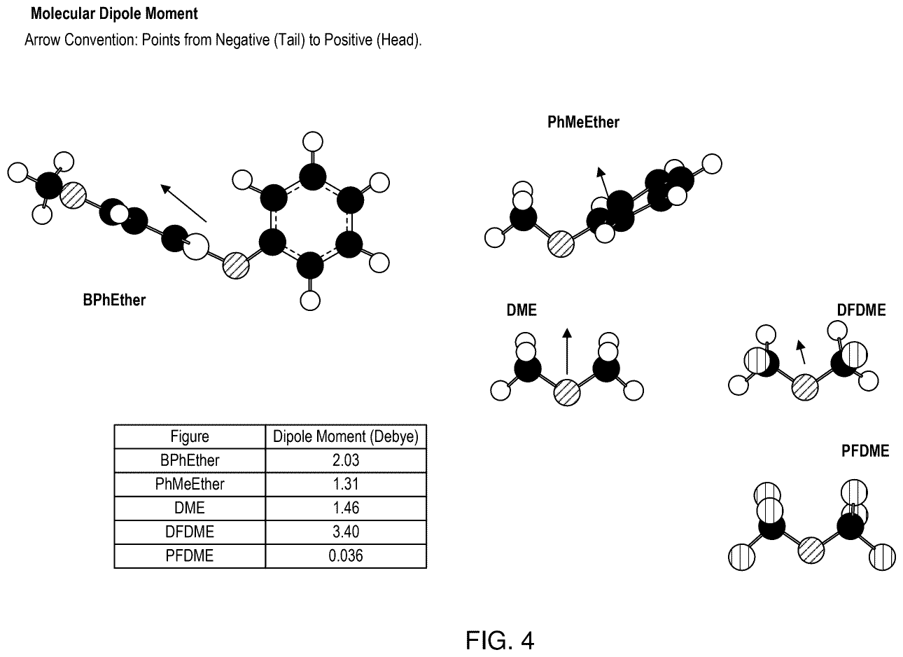

FIG. 4 shows the structure and dipole moments for benzylphenyl ether (BPhEther, μ=2.03 D), phenylmethyl ether (PhMeEther, μ=1.31 D), dimethyl ether (DMVE, μ=1.46 D), difluorodimethyl ether (DFDME, μ=3.40 D) and perfluorodimethyl ether (PFDME, μ=0.036 D). The PFDME repeating unite (μ=0.036 D) represents the minimum dipole moment that shows optimal bonding to the disk so as to decrease the thickness of the lube and improve spacing. This effect persists until an upper dipole limit of about 1.69 D is obtained for the repeating unit. However, dipole moments greater than 1.69 D can be used, depending on the molecular geometry, for example 2.0 D.

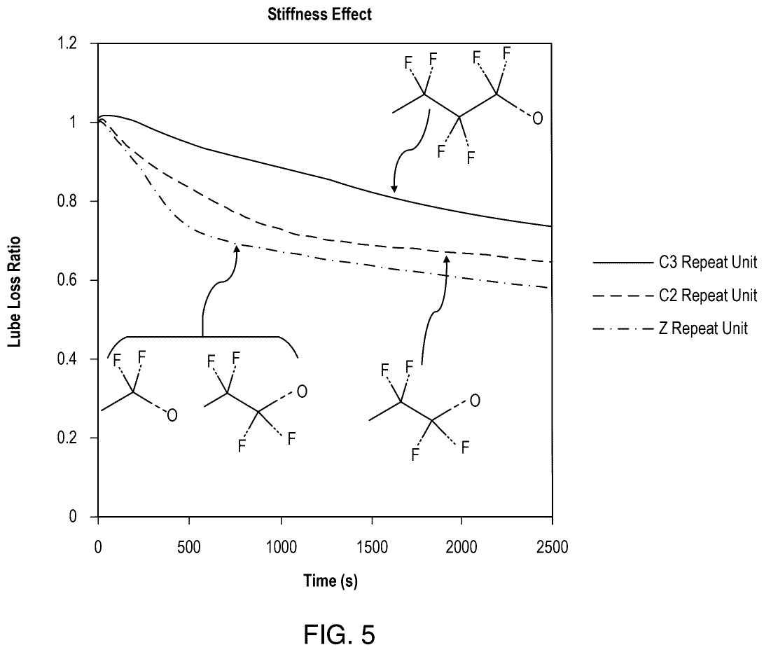

FIG. 5 shows the enhancement of enthalpy of vaporization as a function of the structure of the repeating unit, where the lube loss ratio is graphed as a function of time. The lube loss ratio is defined as the lube thickness normalized by the initial lube thickness. As can be seen, a C₃ repeat unit has the highest lube loss ratio (0.75 at 2500 seconds (sec)), followed by the C₂ repeat unit (0.65 at 2500 sec). A mixed repeat unit (Z repeat unit) had the lowest lube loss ratio (0.58 at 2500 sec). The changes to the repeat unit stiffness decrease the lube loss at elevated temperatures. This can be also represented in changes in the enthalpy of vaporization of molecules which represent the types of repeat units: where pentafluoroethyl trifluoromethyl ether (C₃F₈O) is approximately 21.4 kJ/mol, and bis(trifluoromethyl) ether (C₂F₆O) is 17 kJ/mol; these two molecules can be combined to create the C₃, C₂, and Z repeat units. The modified repeat unit utilizes the enhanced enthalpy of vaporization via increased interaction energy to reduce lube loss at elevated temperatures. The increased interaction energy is defined by the dipole moment of the repeat unit such that a dipole moment greater than 0.036 D satisfies the lubricant design. The added interaction energy will decrease the lube loss and also increase the head-disk clearance. However, there will be a minor decrease in the lubricity of the lubricant.

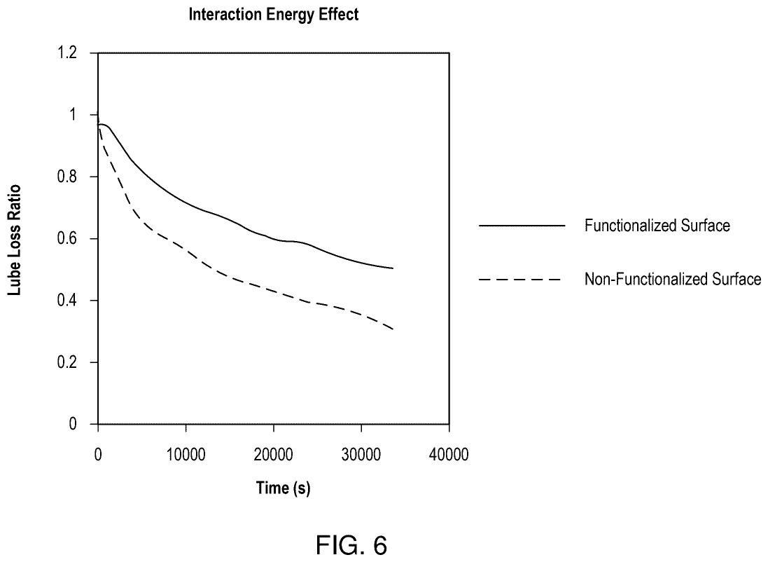

FIG. 6 shows the benefits of utilizing interaction energy to decrease lube loss on the disk surface. Utilizing interaction energy to decrease lube loss allows for selectively decreasing lube loss on the functionalized disk surface rather than the non-functionalized head surface. This can be seen by observing the lube loss off of a functionalized surface versus a non-functionalized surface. This is different than changing the stiffness which decreases lube loss regardless of the surface functionalization.

Molecular weight also affects the clearance. Consider the molecular weight of the polymer P between the anchoring functional groups R, as shown in formula (VIII):

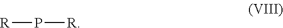

The clearance is defined as:

$$clearance ∝ \frac{1}{( \sqrt{MW} ) ( h ) ( f )}$$

where MW is the molecular weight of the lubricant, h is thickness and f is flexibility.

Just like how the elastic modulus is proportional to the mass between crosslinks, the HDI clearance is proportional to the mass between anchoring functional groups. For example, if a first example lubricant, Lube 1, has a monolayer thickness of 8.8 Å and a MW of 3050, and a second example lubricant, Lube 2, has the same design but has a monolayer thickness of 11.5 Å at a MW of 4670, then the predicted monolayer thickness of Lube 1 is 9.34 Å when considering the entire MW. On the other hand, the predicted monolayer thickness is 8 Å when considering the MW of one arm. Since the actual monolayer thickness of 8.8 Å is between 9.34 Å and 8 Å for Lube 1, and the value of 8 Å assumes 100% anchoring and 9.34 Å assumes 0% anchoring, this suggests the actual lube only has partial anchoring to the carbon overcoat. Following this logic, any additional anchoring groups should further push the monolayer thickness closer to 8 Å. That is, in a data storage system, the lubricant may be a monolayer with an average thickness being in the range of 5 to 12 Å, or at 8 Å.

### Design Strategy—Repeat Unit Modification

Incorporating larger dipole moments into the main-chain repeat unit can further enhance the binding of the lubricant to the disk and not the head. Additionally, larger dipole moments improve the HDI clearance. However, changing the molecular design will change both the molecular stiffness and interaction energy. To minimize the effect on lubrication of incorporating anchoring functional groups into the molecule, an enthalpy of vaporization is greater than 17 kJ/mol (typical fluorinated repeat unit) and less than 40.7 kJ/mol will be used for the added groups that additionally have a larger dipole moment of 0.036 D. Typical end groups have enthalpies of vaporization of between 60 and 70 kJ/mol.

### Example 1

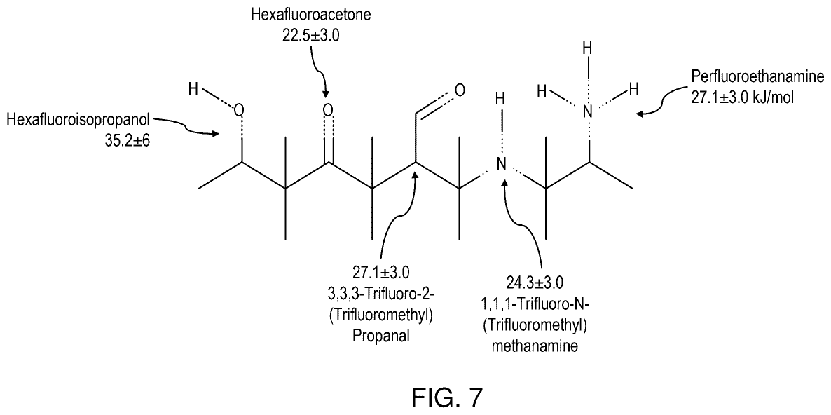

FIG. 7 shows an example of the type of structures that can enhance the dipole moment of the molecule and enthalpy of vaporization. They range from oxygen containing groups, nitrogen containing groups and doubly bonded carbon. However, the possible groups are not limited to the groups shown in FIG. 7. The enthalpies of these structures, i.e., molecular structures of repeat group analogs, are tabulated in Table 2.

TABLE 2
Enthalpies of Groups Incorporated Into the Lubricant Chain.

| Group | Enthalpy (kJ/mol) |
|---|---|
| Hexafluoroisopropanol | 35.2 ± 6 |
| Hexafluoroacetone | 22.5 ± 3.0 |
| 3,3,3-Trifluoro-2-(trifluoromethyl)propanal | 27.1 ± 3.0 |
| Perfluoroethanamine | 27.1 ± 3.0 |
| 1,1,1-Trifluoro-N- | 24.3 ± 3.0 |
| (trifluoromethyl)methanamine | |

### Example 2

Enhancing the dipole moment can be accomplished via atom transfer radical polymerization (ATRP) followed by Simon's/Fowler's process to yield formula (IX):

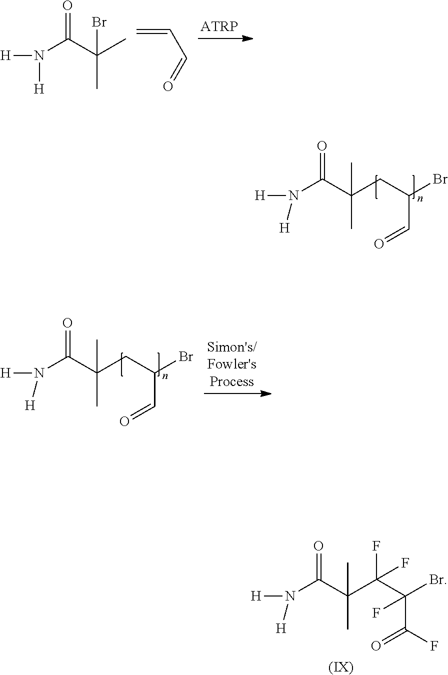

### Example 3

Enhancing the dipole moment can be accomplished via a ring opening (e.g., based on cyclobutane) polymerization using an acid or base to yield a lubricant of Formula (X):

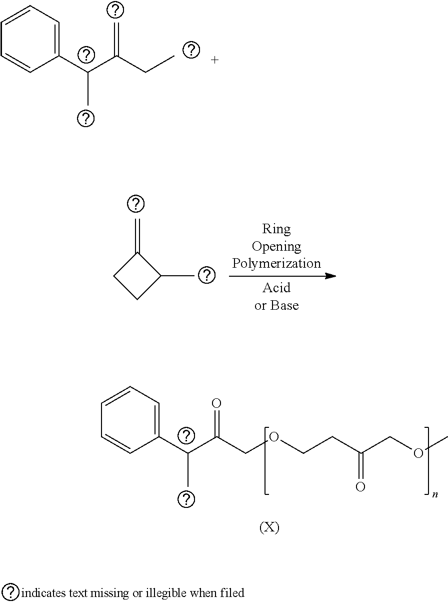

where n=5 to 500.

Perfluorination of a non-fluorinated polymer can be achieved by a Simon/Fowler's process to yield formula (XI):

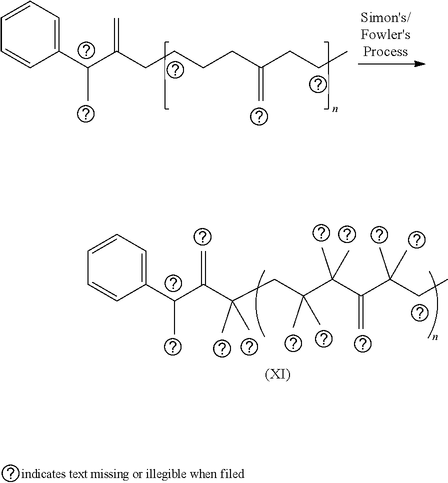

where n=5 to 500.

### Example 4

Different side chain units can be synthesized by a ring opening polymerization in acid or base to yield formula (XII):

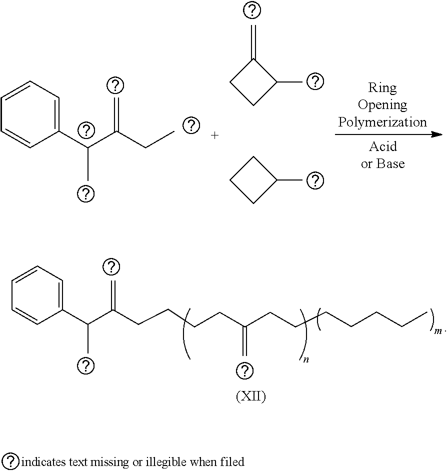

where n, m each independently=5 to 500.

Similarly, different side chain units can be synthesized using perfluorination by Simon/Fowler's process to yield formula (XIII):

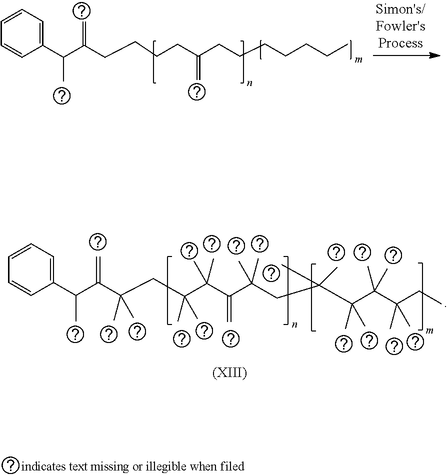

where n, m each independently=5 to 500.

### Lubricant Compositions

In general, the lubricant of the disclosure can have the general formula (I):

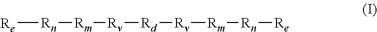

where R_{b} may be a C₁-C₄ fluorinated repeating unit having a higher interaction energy, Rₘ if present may be a C₁-C₄ fluorinated repeating unit having at least one functional group having a dipole moment larger than 0.036. Rₙ and Rₘ additionally may have an enthalpy of vaporization between 17 kJ/mol (typical fluorinated repeat unit) and 40.7 kJ/mol, which may be independent of the dipole moment. Rₑ is an anchoring functional group, Rᵥ if present is an anchoring functional group that does not have to be different from Rₑ and one of Rₑ and Rᵥ is present, and R_{d} is a linker. As shown in formula (I), R_{d} is divalent. However, R_{d} can be multivalent so that a star shaped lubricant may result. Formula (I) can thus be rewritten as formula (Ia):

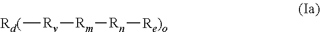

where o is from 2 to 6 and R_{d}, Rᵥ, Rₘ, Rₙ and Rₑ are defined above.

In one aspect, one such lubricant includes or is according to general formula (II), (III) or (IV):

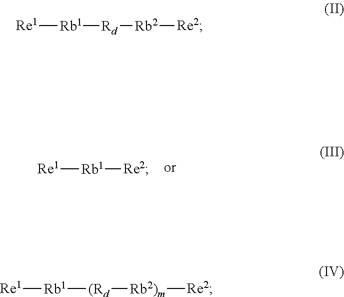

where R_{d}, when present, is a divalent linking segment optionally including a first anchoring functional group engageable with a protective overcoat of a magnetic recording medium. Each Rb¹ and Rb², when present, independently is a chain segment having an optimized dipole moment, and m=1-100. Each of Re¹ and Re² independently includes a group having an optimized dipole moment. The lubricant of the disclosure can also be expressed as formula (IIa), (IIIa) or (IVa):

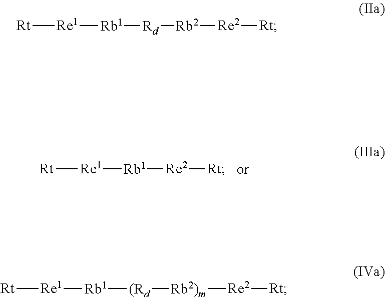

with R_{d}, Rb¹ and Rb² as defined above, Re¹ and Re² independently includes a group having an optimized dipole moment and each Rt independently includes a group that is —CH₂OCH₂(CH₂)ₙ(Ra)ₙ₋₁ or —OCH₂(CH₂)ₙ(Ra)ₙ₋₁ with Ra being a second anchoring functional group where n=1-10 and m=1-100.

### Divalent Linking Segment (Rc)

In one aspect, based on the formulas (I) and (Ia) above, a lubricant of the disclosure may have general formulas general formulas (II) or (IV):

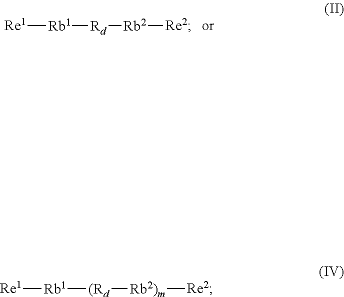

wherein m is from 1 to 20; the divalent linking or center segment R_{d} optionally further includes one or more first anchoring functional groups, and/or one or more cyclic functional groups.

In one aspect, R_{d} includes or has general formula (XIV):

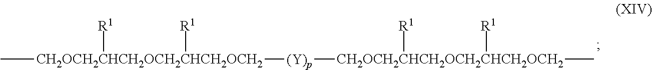

wherein each Y independently includes:

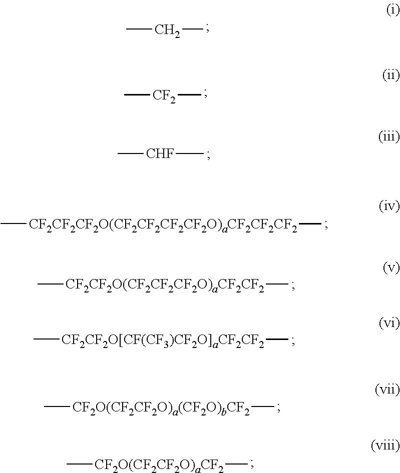

or a combination thereof;
wherein each a is, independently from 1 to 20,
wherein each b, when present, is independently from 1 to 20;
wherein p is from 1 to 20; and
wherein at least one R¹ is an anchoring functional group engageable with a protective overcoat of a magnetic recording medium, formed from B, Si, a pnictogen, a chalcogen, a halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

In a related aspect, at least one R¹ present on the linking segment Re may optionally be a cyclic functional group including an alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. In one aspect, at least one R¹ present on the linking segment Re may be a hydroxyl moiety (—OH). In another aspect, each R¹ present on the linking segment Re may include a hydroxyl moiety, e.g., is a hydroxyl moiety or is substituted with a hydroxyl moiety. In another aspect, each R¹ present on the linking segment Rc is a hydroxyl moiety.

In an aspect, R_{d} includes or is of general formula (XV):

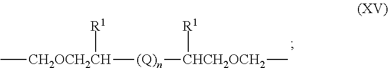

wherein each Q independently includes:

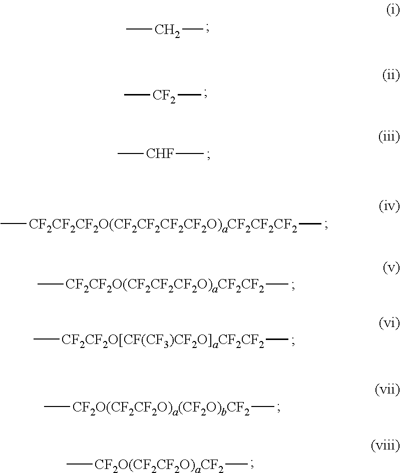

or a combination thereof;
wherein each a is, independently from 1 to 20, or from 1 to 10, or from 1 to 5;
wherein each b, when present, is independently from 1 to 20 or from 1 to 10, or from 1 to 5; wherein n is from 1 to 20 or from 1 to 10, or from 1 to 5; and
wherein at least one R¹, when present, is an anchoring functional group engageable with a protective overcoat of a magnetic recording medium, including B, Si, a pnictogen, a chalcogen, a halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, wherein two or more R* may join together to form a ring structure.

In a related aspect, at least one R¹, when optionally present on the linking segment Rc, may be a cyclic functional group including an alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. In one aspect, at least one R¹ present on the linking segment Re may be a hydroxyl moiety (—OH). In another aspect, each R¹, if present on the linking segment Rc, includes a hydroxyl moiety, e.g., is a hydroxyl moiety, or is substituted with a hydroxyl moiety. In another aspect, each R¹ present on the linking segment R_{d} is a hydroxyl moiety.

In one aspect R_{d} may be an ester functional group according to general formula (XVI), (XVII), or a combination thereof:

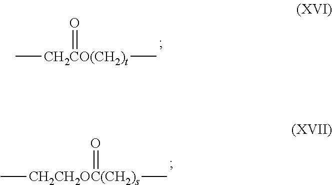

where t, when present, is from 1 to 20, or from 1 to 10, or from 1 to 5; and wherein s, when present, is from 1 to 20, or from 1 to 10, or from 1 to 5.

### Main Chain—Side Chain Segment (Rb)

In one aspect, where a lubricant has general formula (III):

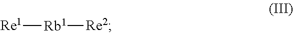

and/or in an aspect where a lubricant has general formulas (II) or (IV):

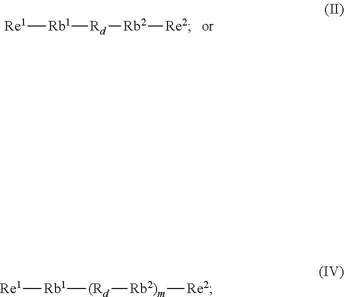

wherein m is from 1 to 20; the main chain segment Rb¹ and/or the side chain segments Rb¹ and Rb² include a fluoroalkyl, fluoroalkenyl, perfluoroalkyl, or perfluoroalkyl ether moiety and at least one functional group having a dipole moment larger than 0.036 D and optionally an enthalpy of vaporization between 17 kJ/mol and 40.7 kJ/mol. In one aspect, each chain segment present in the lubricant may have the formula:

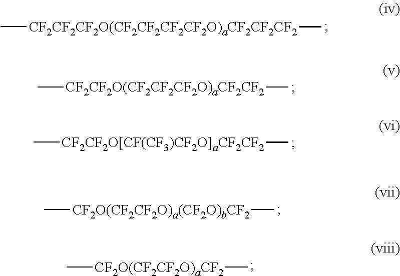

or a combination thereof, wherein each a is, independently from 1 to 100, or from 1 to 20, or from 1 to 10, or from 1 to 5, and wherein each b, when present, is independently from 1 to 100, or from 1 to 20, or from 1 to 10, or from 1 to 5.

In one or more aspects, the lubricants are stable above about 250° C., or above about 300° C., or above about 325° C., or above about 350° C., or above about 375° C., and less than or equal to about 450° C., or 425° C. when determined in air, nitrogen, helium, or 90 vol % helium 10 vol % oxygen.

In one or more aspects, the lubricant has a weight average molecular weight of greater than or equal to about 0.5 kiloDalton (kDa), or from about 1 to about 20 kDa, or from about 2 to about 10 kDa, or from about 3 to about 7 kDa, or from about 1 to about 5 kDa, or 2 to about 4 kDa.

In one or more aspects, the lubricant has a weight average molecular weight of greater than or equal to about 500 grams per mole (g/mol), or from about 1,000 to about 20,000 g/mol, or from about 2,000 to about 10,000 g/mol, or from about 3,000 to about 7,000 g/mol, or from about 1,000 to about 5,000 g/mol, or 2,000 to about 4,000 g/mol.

In one or more aspects, the lubricants are essentially pure compounds, having a polydispersity, defined as the number average molecular weight Mn divided by the weight average molecular weight Mw (Mn/Mw) from about 1 to 2, or from about 1 to about 1.5, or from about 1 to about 1.1, or from about 1 to about 1.05.

Returning to FIG. 2, in one or more aspects, the magnetic recording medium 200 has a stacked structure which includes a lubricant layer 216 according to the disclosure on the overcoat layer 214.

In one or more aspects, the average thickness of the lubricant layer of the magnetic recording medium is less than about 10 nanometers (nm), or less than about 5 nm, or less than or equal to about 1 nm. In some aspects, the lubricant of the magnetic recording medium has an average thickness from about 0.1 nm to about 10 nm, or from about 0.1 nm to about 1 nm.

In one or more aspects of the magnetic recording medium, the lubricant may have a bonding percentage of at least about 30%, or at least about 50%, or at least about 70%, or at least about 80%, or at least about 90%, and less than or equal to about 99%, or less than or equal to about 95%, corresponding to a post-stripping bonding level of the lubricant to the total area of an upper surface of the protective overcoat.

In one aspect, a magnetic data storage system may include a magnetic head; a magnetic recording medium according to any one or a combination of aspects disclosed herein including a lubricant according to one or more aspects disclosed herein, a drive mechanism for moving the magnetic head over the magnetic recording medium; and a controller electrically coupled to the magnetic head for controlling operation of the magnetic head.

### Media Fabrication

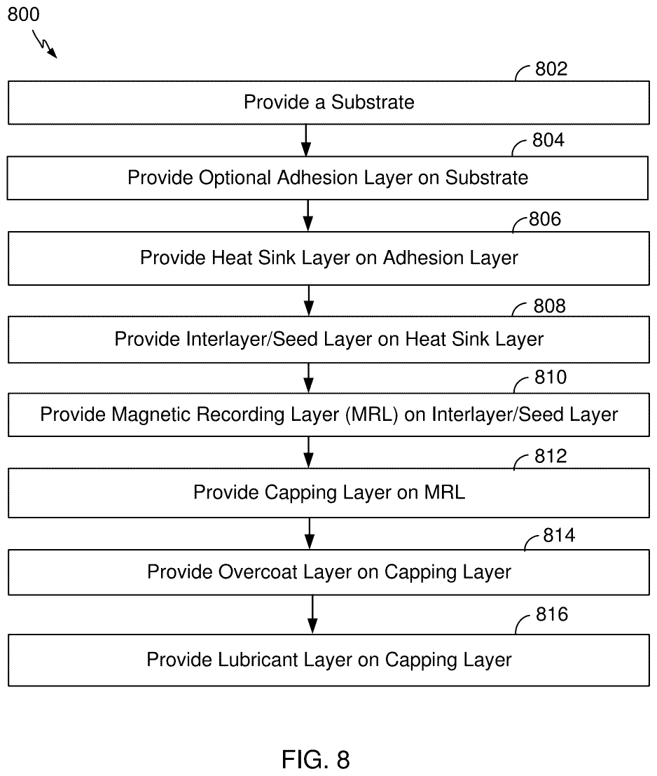

FIG. 8 is a flowchart of an exemplary process 800 for fabricating a HAMR medium that includes a lubricant in accordance with an aspect of the disclosure. In one aspect, the process 800 can be used to fabricate the HAMR media described above, including medium 200 shown in FIG. 2.

At block 802, the process provides a substrate (e.g., substrate 202). At block 804, the process provides an optional adhesion layer (e.g., adhesion layer 204). At block 806, the process provides a heat sink layer (e.g., heat sink layer 206). In one aspect, at block 908, the process may additionally provide an interlayer/seed layer (e.g., interlayer 208). At block 810, the process provides a magnetic recording layer (MRL) (e.g., MRL 210). At block 812, the process provides a capping layer (e.g., capping layer 212).

At block 814, the process provides an overcoat layer (e.g., overcoat layer 214). At block 816, the process provides a lubricant layer, e.g., lubricant layer 218.

It is important to note that in alternative approaches, the lubricant layer formed above the protective overcoat may include any of the multidentate fluoroalkyl, fluoroalkenyl, perfluoroalkyl, or perfluoropolyether boundary lubricants described herein, singly and/or in any combination.

In various aspects, the lubricant layer can be formed on the magnetic recording medium, specifically on the protective overcoat, via a dip coating method. For instance, in one aspect the magnetic recording medium may be dipped into a lubricant bath including the multidentate perfluoropolyether boundary lubricant according to one or more aspects of the disclosure and a fluorocarbon solvent such as HFE7100 (hydrofluoroether) or VERTREL-XF (hydrofluorocarbon). After a predetermined amount of time, the magnetic recording medium may be pulled out from the lubricant bath at a controlled rate. The solvent may then evaporate, leaving behind a lubricant layer including the multidentate perfluoropolyether boundary lubricant. The bonding percentage is quantified by stripping the lubricated magnetic recording medium with the solvents used in the lubricant bath at various post-lube time periods.

The thickness of the lubricant layer may be tuned by controlling the submergence duration of the magnetic recording medium in the lubricant bath, the rate at which the magnetic recording medium is removed from the coating solution, and/or the concentration of the boundary lubricant (e.g. the lubricant according to one or more aspects of the disclosure) in the lubricant bath.

In one or more aspects, the concentration of lubricant in the lubricant bath may be in a range from about 0.001 g/L to about 1 g/L. In yet other aspects, the concentration of the lubricant in the lubricant bath may be selected so as to achieve a resulting lubricant layer with a thickness in a range from about less than or equal to about 10 nanometers (nm), or less than or equal to about 5 nm, or less than or equal to about 1 nm or from 0.1 nm to less than about 1 nm.

Likewise, the formation of the lubricant layer on the surface of the magnetic recording medium, specifically on the surface of the protective overcoat, is not limited to dip coating, but may also involve spin coating, spray coating, a vapor deposition, combinations thereof, or any other suitable coating process as would be understood by one having skill in the art upon reading the present disclosure.

### Burnishing

Burnishing is a manufacturing process for HDD to reduce asperities and the disk surface. If the lubricant film thickness exceeds its monolayer thickness, the extra lubricant is readily removed by burnishing. On the contrary, when the lubricant film thickness is below the monolayer thickness, the lubricant remains undisturbed. Thus, the monolayer film thickness could be determined by burnishing the disk surface as a function of film thickness. The changes in the lubricant film thickness before and after burnish provide an estimate for the monolayer thickness.

It should be noted that methodology presented herein for at least some of the various aspects may be implemented, in whole or in part, in computer hardware, by hand, using specialty equipment, etc. and combinations thereof.

Moreover, any of the structures and/or steps may be implemented using known materials and/or techniques, as would become apparent to one skilled in the art upon reading the present disclosure.

In some aspects, for the processes described herein, they can perform the sequence of actions discussed above in a different order. In other aspects, the processes can skip one or more of the actions. In still other aspects, one or more of the actions are performed simultaneously. In some aspects, additional actions can be performed. For example, in one aspect, the process may include any additional actions needed to fabricate the magnetic recording layer structure.

In some aspects, the forming or deposition of such layers can be performed using a variety of deposition sub-processes, including, but not limited to physical vapor deposition (PVD), direct current (DC) sputter deposition, ion beam deposition, radio frequency sputter deposition, or chemical vapor deposition (CVD), including plasma enhanced chemical vapor deposition (PECVD), low pressure chemical vapor deposition (LPCVD) and atomic layer chemical vapor deposition (ALCVD). In other embodiments, other suitable deposition techniques known in the art may also be used.

The terms “on,” “above,” “below,” and “between” as used herein refer to a relative position of one layer with respect to other layers. As such, one layer deposited or disposed on/above or below another layer may be directly in contact with the other layer or may have one or more intervening layers. Moreover, one layer deposited or disposed between layers may be directly in contact with the layers or may have one or more intervening layers.

The above description is made for the purpose of illustrating the general principles of the present disclosure and is not meant to limit the inventive concepts claimed herein. Further, particular features described herein can be used in combination with other described features in each of the various possible combinations and permutations.

It should be noted that in the development of any such actual aspect, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the device, system and/or method used/disclosed herein can also include some components other than those cited.

Unless otherwise specifically defined herein, all terms are to be given their broadest possible interpretation including meanings implied from the specification as well as meanings understood by those skilled in the art and/or as defined in dictionaries, treatises, and the like.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 20 angstroms (Å) refers to a thickness of 20 Å+/−2 Å, e.g., from 18 Å to 22 Å in this example.

In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.” The term “and/or” refers to both the inclusive “and” case and the exclusive “or” case, and such term is used herein for brevity. For example, a composition including “A and/or B” may include A alone, B alone, or both A and B.

Various components described in this specification may be described as “including” or made of certain materials or compositions of materials. In one aspect, this can mean that the component include the particular material(s).

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. It is further noted that the term “over” as used in the present application in the context of one component located over another component, may be used to mean a component that is directly on another component and/or in another component (e.g., directly on a surface of a component or embedded in a component). Thus, for example, a first component that is over the second component may mean that (1) the first component is over the second component, but not directly touching the second component, (2) the first component is directly on (e.g., directly on a surface of) the second component, and/or (3) the first component is in (e.g., embedded in) the second component. The term “about ‘value X’”, or “approximately value X,” as used in the disclosure shall mean within 10 percent of the ‘value X’. For example, a value of about 1 or approximately 1 would mean a value in a range of 0.9-1.1. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range. In the disclosure various values (e.g., value X) may be specified, described and/or claimed. In one embodiment, it should be understood that the value X may be exactly equal to X. In one embodiment, it should be understood that the value X may be “about X,” with the meaning noted above.

While various aspects have been described above, it should be understood that they have been presented by way of example only, and not limitation. Thus, the breadth and scope of an aspect of the present invention should not be limited by any of the above-described exemplary aspects, but should be defined only in accordance with the following claims and their equivalents.

1. A lubricant comprising:
a plurality of segments according to general formula (I): 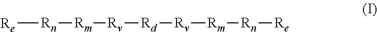
where:
Rₙ when present is a C₁-C₄ fluorinated repeating unit having a dipole moment greater than 0.036 debye (D),
Rₘ when present is a C₁-C₄ fluorinated repeating unit having a dipole moment greater than 0.036 D but different than Rₙ, and at least one of Rₙ or Rₘ is present,
Rₑ is a first anchoring functional group,
Rᵥ is optionally a second anchoring functional group, and
R_{d} is a linker.

2. The lubricant of claim 1, wherein the dipole moment of Rₙ and Rₘ are each independently in a range of 0.036 D to 1.69 D.

3. The lubricant of claim 1, wherein Rₙ or Rₘ, when present, have an enthalpy of vaporization of greater than 17 kiloJoules per mole (kJ/mole) and less than 40.7 kJ/mol.

4. The lubricant of claim 1, wherein Rₑ has an enthalpy of vaporization of between 60 kJ/mol and 70 kJ/mol.

5. The lubricant of claim 1, wherein Rₙ and Rₘ are each independently selected from:

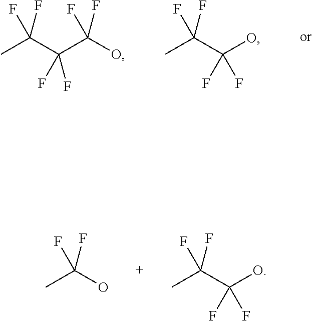

6. The lubricant of claim 1, wherein Rₙ and Rₘ are each independently formed from: benzyl phenyl ether, phenylmethyl ether, dimethyl ether, difluorodimethyl ether or perfluorodimethyl ether.

7. The lubricant of claim 1, wherein Rₙ and Rₘ each independently comprises moieties selected from hexafluoroacetone, heaxfluoroisopropanol, perfluoroethanamine, 3,3,3-Trifluoro-2-(trifluoromethyl)propanal or 1,1,1-Trifluoro-N-(trifluoromethyl)methanamine.

8. The lubricant of claim 1, wherein Rₑ and Rᵥ independently each comprises at least one of B, Si, a pnictogen, a chalcogen, a halogen, —OR*, —NR*₂, —NR*—CO—R*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

9. The lubricant of claim 1, wherein Rₑ and Rᵥ each comprises a hydroxyl (—OH) moiety.

10. A data storage system, comprising:
at least one magnetic head;
a magnetic recording medium including the lubricant of claim 1;
a drive mechanism for positioning the at least one magnetic head over the magnetic recording medium; and
a controller electrically coupled to the at least one magnetic head for controlling operation of the at least one magnetic head.

11. The data storage system of claim 10, wherein the lubricant is a monolayer with a thickness being 5 to 12 Å on average.

12. The data storage system of claim 10, wherein the lubricant is a monolayer with a thickness being 8 Å on average.

13. A magnetic recording medium, comprising:
a magnetic recording layer on a substrate;
a protective overcoat on the magnetic recording layer; and
a lubricant layer comprising the lubricant according to claim 1 on the protective overcoat.

14. A data storage system, comprising:
a slider comprising at least one magnetic head and an air bearing surface (ABS), wherein the lubricant according to claim 1 is disposed on the ABS; and
a magnetic recording medium including a magnetic recording layer;
wherein the slider is configured to write information to the magnetic recording layer using heat assisted magnetic recording (HAMR).

15. A method of synthesizing a component of the lubricant of claim 1, comprising atom transfer radical polymerization (ATRP) followed by Simon's/Fowler's process to yield formula (IX):

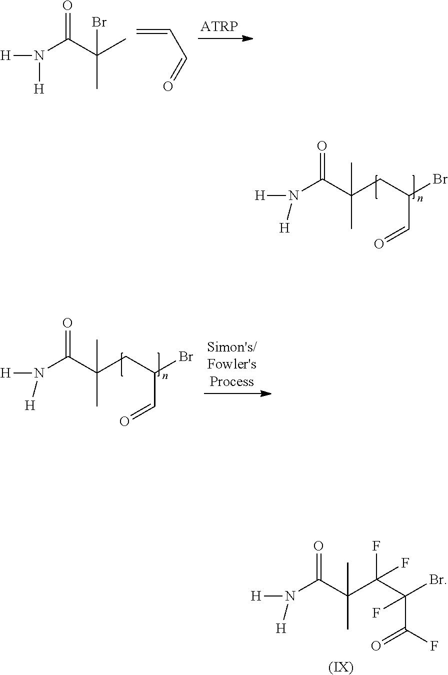

16. A method of synthesizing a component of the lubricant of claim 1, comprising a ring opening based on cyclobutane polymerization using an acid or base to yield a lubricant of formula (X):

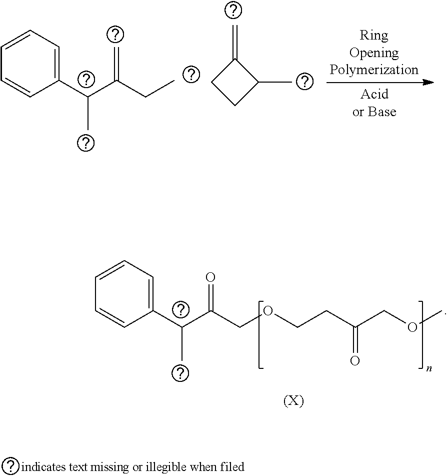

17. A method of synthesizing a component of the lubricant of claim 1, comprising perfluorination of a non-fluorinated polymer by Simon/Fowler's process to yield formula (XI):

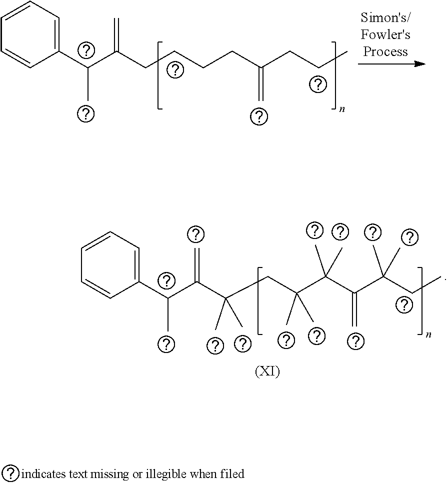

18. A lubricant comprising:
a plurality of segments according to general formula (I): 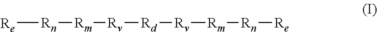
where:
Rₙ when present is a C₁-C₄ fluorinated repeating unit having an enthalpy of vaporization of greater than 17 kiloJoules per mole (kJ/mole) and less than 40.7 kJ/mol,
Rₘ when present is a C₁-C₄ fluorinated repeating unit having an enthalpy of vaporization of greater than 17 kJ/mole and less than 40.7 kJ/mol, but different than Rₙ, and at least one of Rₙ or Rₘ is present,
Rₑ is a first anchoring functional group,
Rᵥ is optionally a second anchoring functional group, and
R_{d} is a linker.

19. The lubricant of claim 18, wherein Rₑ has an enthalpy of vaporization of between 60 and 70 kJ/mol.

20. The lubricant of claim 18, wherein a dipole moment of Rₙ and Rₘ are each independently in a range of 0.036 D to 1.69 D.

21. The lubricant of claim 18, wherein Rₙ and Rₘ are each independently selected from: [chemical structure]
